(19) United States
(12) Patent Application Publication
(10) Pub. No.: US 2026/0317843 A1
(43) Pub. Date: Oct. 15, 2026

(54) VEGETABLE EXTRACTS FOR TANNING

(71) Applicant: TFL Ledertechnik GmbH, Rheinfelden (DE)

(72) Inventors: Florian DÖPPERT, Schliengen (DE); Volker RABE, Leverkusen (DE); Jens FENNEN, Grenzach-Wyhlen (DE); Petra BALBO, Rheinfelden (DE)

(73) Assignee: TFL Ledertechnik GmbH, Rheinfelden (DE)

(21) Appl. No.: 19/104,459

(22) PCT Filed: Aug. 16, 2023
(86) PCT No.: PCT/EP2023/072603

§ 371 Date: Feb. 18, 2025

(30) Foreign Application Priority Data
Aug. 19, 2022 (DE) 10 2022 121 017.0

(51) Int. Cl. C14C 3/12; C14C 3/28

(52) U.S. Cl. CPC C14C 3/12; C14C 3/28

(57) ABSTRACT

A tannin-containing product which can be prepared or is prepared by extraction of a vegetable tannin-containing material by (i) an aqueous solution or dispersion containing one or more polar organic solvents in the form of an extract, or (ii) a supercritical solvent in the form of a residue of the extraction, or (iii) pure water in the form of a residue of the extraction, or (iv) a mixture of a supercritical and a polar solvent in the form of a residue of the extraction, is used for tanning and/or retanning hides or skins or their intermediate products resulting from leather production.

### CROSS-REFERENCE TO RELATED APPLICATIONS

This application is a 371 National Phase of PCT/EP2023/072603, filed Aug. 16, 2023, which claims priority from German Patent Application No. 10 2022 121 017.0, filed Aug. 19, 2022, both of which are incorporated herein by reference as if fully set forth.

### TECHNICAL FIELD

The invention relates to the use of a tannin-containing product which can be prepared or is prepared by extraction of a vegetable tannin-containing material by means of (i) an aqueous solution or dispersion containing one or more polar organic solvents or (ii) by means of a supercritical solvent or (iii) pure water or (iv) a mixture of a supercritical and a polar solvent, as described below and in the claims, for tanning and/or retanning hides or skins or intermediate products thereof obtained in the production of leather, and/or also related subject matters of the invention as set forth below and in particular in the examples.

### BACKGROUND

During tanning, collagen fibers from animal skin are cross-linked to prevent bacterial or fungal degradation. Common tanning agents are chromium sulfate, glutardialdehyde, vegetable tanning agents or synthetic tanning agents. The synthetic tanning agents, often referred to as synthanes or synonymously as syntans, are usually aldehyde condensation products of aromatic bases, in particular phenol, cresol, naphthalene and naphthol, which have been made soluble by sulfonation or sulfomethylation. Condensates of naphthalene sulfonic acids, phenolsulfonic acid, diphenylsulfones or sulfonated diaryl ethers with formaldehyde and/or urea are particularly preferred. Such condensates are known, for example, from Herfeld's (editor) “Bibliothek des Leders (Library of the Leather)”, vol. 3, pages 53 to 59, Umschau-Verlag 1984 or Reich, G. Theorie und Praxis der organischen Gerbstoffe (Theory and practice of organic tanning agents), Teil 2: Synthetische organische Gerbstoffe (Part 2: Synthetic organic tanning agents), Das Leder, 1996, 157-171, and can be produced according to the processes described in the references given there.

With the widespread acceptance of chrome sulfate or glutardialdehyde tanning, the use of both vegetable tanning agents and syntans has shifted and these are mainly used in the retanning process. In this process step, the collagen fibers are already cross-linked, so the focus is less on the tanning effect and more on fine-tuning the desired leather properties. Here too, the properties of the leather can be controlled more precisely with syntans due to the more uniform chemical basis. However, the effect of the non-tanning agents of vegetable tanning agents of filling looser parts of the hide, which ensures a more uniform thickness over the entire leather surface, cannot be achieved to the same extent. For this purpose, larger quantities of syntans or usually other products with a different chemical basis, such as resin tanning agents or other polymers (e.g. acrylates), must be used in the retanning process. A further disadvantage is the fact that all these synthetic products are petroleum-based and therefore run counter to the desire for a more sustainable leather value chain.

There has been no lack of attempts to overcome or limit the technical and ecological disadvantages of today's synthetics and to replace some of the ingredients with renewable materials.

It is known to tan animal hides and skins using vegetable tanning (i.e. tanning with vegetable tanning agents, also known as vegetable tanning (VG)). See e.g. G. Moog, der Gerber, Professionelle Lederherstellung (Professional leather production), Eugen Ulmer KG, 2016. Vegetable tanning agents are very diverse and usually complex compounds, which are also known as tannins or polyphenols. They are found in almost all plants. They serve as protection against rotting, browsing by game and fungal or mold infestation and can be found in bark (e.g. oak, spruce, mimosa or willow bark), wood (e.g. oak, quebracho or chestnut wood), roots (e.g. badan, canaigre), leaves (e.g. sumac or gambir), fruits (e.g. valonea, trillo, myobalans or tara) and outgrowths (e.g. galls or knobs). Normally the substances are leached out with water to form a tanning broth and have an astringent effect.

For example, a distinction is made between so-called (hydrolyzable) pyrogallol tannins and condensed pyrocatechin tannins. The former contain sugars, which can lead to the formation of acid in the broths due to fermentation, while the latter contain large, poorly soluble tanning particles (so-called phlobaphenes), which settle as sludge and can then no longer have a tanning effect. The tanner must be very familiar with the properties of the tanning agents to be used—each tanning agent behaves differently in terms of solubility, particle size, diffusion, binding, color, fullness, strength, odor, etc.

In recent decades, attempts have been made to replace vegetable tanning agents with the aforementioned synthetic tanning agents, the syntans, which have largely reproducible, uniform particle sizes and consistent, defined properties.

On the other hand, however, there is still and recently has been an increasing need for new vegetable tanning agents, as these are natural substances and generally have good ecological and/or biological compatibility. When disposing of leather and its manufacture, it is desirable to avoid synthetic materials and prefer naturally degradable substances. There has been no lack of attempts to overcome the disadvantages, both technical and ecological, of today's synthetics or other tanning agents and to replace at least some of the ingredients with renewable materials.

### SUMMARY

It has now been found that when a residual residue obtained by means of an aqueous organic solvent, a supercritical solvent, such as supercritical carbon dioxide, or a mixture of a supercritical and a polar solvent, or in particular an extract of a tannin-containing vegetable material, for example green tea, is added to the liquor as a tanning agent, a surprisingly very good tanning and/or retanning effect is achieved, which enables the production of leathers/tanned hides with very good properties as described in more detail below, and in some cases shows advantageous results in tanning and retanning compared to known vegetable tanning agents and/or requires or exhibits lower concentrations of residue or extract and/or other positive properties.

The properties of green tea extracts may not only be due to the content of polyphenols and/or proanthocyanidins.

Surprisingly, the use of (aqueous polar solvents, in particular ethanol/water) extracts, especially of green tea, as tanning agent-containing products has been found to have a better tanning effect and improved properties in retanning compared to the use of water extracts, and at least comparable and in some cases better results in leather production compared to already known vegetable tanning agents.

Conversely, carrying out an extraction with pure water (without added solvent) or with supercritical solvents in the residues (quasi “pomace”) of the extracted material can result in products that are relatively enriched in tanning agents and exhibit a stronger tanning effect than the vegetable starting material.

Thus, the residues or in particular extracts to be used according to the invention can be used to obtain good or improved shrinkage temperature (“TS”) compared to known vegetable tanning agents, better or good penetration (and thus more uniform tanning), better or good evenness (uniformity of coloration) and/or better or good dyeability, better or good fullness, better or good softness, better or good tightness, better or good grain break, better or good color intensity or two or more of these properties of the resulting leather or tanned hide can be obtained compared to leathers or hides produced with known vegetable tanning agents such as tara or mimosa. As a rule, a comparable or better overall classification is found with comparable quantities or concentrations of tanning agents.

An important measure for tanning is the hydrothermal stability of the leather, the so-called shrinkage temperature (TS). This can be measured using the DIN 53336:1977-01 method. The shrinkage temperature of an untanned hide is preferably below 60° C. An increase above this (e.g. to 65° C. or higher) indicates tanning; for example, when tanning with vegetable tanning agents, the shrinkage temperature is more than 60° C., for example 65-85° C., depending on the type.

The other properties mentioned are determined by expert assessment and classified qualitatively on the basis of the following values, where “+” means a positive characteristic and “−” a negative characteristic of the property tested:
+3/−3 extreme manifestation,
+2/−2 significant manifestation,
−1/+1 manifestation,
−0.5/+0.5 slight manifestation,
0 reference value

Other positively influenced properties are improved color intensity combined with good color uniformity and penetration; a pleasant round and supple feel and excellent grain break of the leather before and after milling.

A special feature is the excellent inner softness of the tanned or retanned material with good fullness and grain elasticity.

In particular, by extraction with a mixture of water and one or more polar solvents (always referring to an organic polar solvent), for the same amount of extract and in particular polyphenol concentration compared to a known vegetable tanning agent (e.g. from mimosa or, in particular, tara), even with lower absolute quantities of extract and in particular polyphenols in the tanning or retanning process, approximately the same good to better properties, even with comparable absolute quantities, of the resulting tanned leather or rawhides can be found, especially with an extract obtained from green tea (“green tea”) mixed with one or more polar solvents.

The reverse is also true for residues enriched with polyphenols in the residue relative to the total mass.

In general, the tannin-containing products to be used according to the invention advantageously have an enriched proportion of tannins, such as polyphenols, compared to the original plant-based tannin-containing product.

For example, polyphenols can be determined using a Folin/Ciocalteu assay, the sugar content using a phenol-sulfuric assay and the proanthocyanidin content using an acid-butanol assay according to the SOPs of the Bern University of Applied Sciences (Biel, Switzerland) with the aid of UV/VIS spectroscopy.

In a first embodiment, the invention relates to a use of a tannin-containing product that is or can be produced by extracting a vegetable tannin-containing material by means of
(i) an aqueous solution or dispersion containing one or more polar organic solvents in the form of an extract, or
(ii) a supercritical solvent in the form of a residue of the extraction, or
(iii) pure water in the form of an extraction residue, or
(iv) a mixture of a supercritical and a polar solvent in the form of a residue of the extraction,
for tanning and/or retanning hides or skins or their intermediate products resulting from the production of leather.

Advantageously or in a second embodiment of the invention, the tannin-containing product to be used is an extract obtainable or obtained according to variant (i) in liquid or dried form of the aqueous dispersion or in particular solution comprising one or more polar organic solvents.

Alternatively, or in a third embodiment of the invention, the tannin-containing product to be used is a solid or dispersed residue, in particular “pomace”, of an extraction with pure water or in particular with a supercritical solvent, obtainable or obtained according to one of the variants (ii) or (iii).

In an advantageous embodiment, in particular of the embodiments of the invention mentioned so far, phenolic compounds, in particular polyphenols and/or proanthocyanidins, are present as tanning agents in the tannin-containing product to be used.

Preferably, in a further particular embodiment of the invention, the tannin-containing product to be used is an extract of green tea in liquid or dried form, which contains or in particular is the product of an extraction by means of an aqueous dispersion or in particular solution containing one or more polar organic solvents. Preferably, the green tea extract is used for retanning intermediate products resulting from the production of leather from hides or skins, characterized in that the intermediate product or products is or are a material resulting after pickling, in particular rawhide, and this intermediate product is subjected to a tanning or a tanning with subsequent retanning, in each case using the green tea extract. The intermediate product(s) is/are, for example, a material obtainable after a first tanning step, in particular wet white, wet brown or wet blue, wherein this material is subjected to a retanning process using the extract of green tea in each case.

In a further embodiment of the invention, in particular an extract of green tea or the extract from green tea of the respective liquor can be added in solid, for example granular or in particular powder form, to a liquor for tanning or retanning.

A further embodiment of the invention provides that an extract or the extract of green tea is added to one or the respective liquor in liquid form, in particular as an aqueous-ethanolic solution.

A further particular embodiment of the invention relates in each case to one of the embodiments mentioned in the last three paragraphs, wherein a or the extract of green tea is obtained (=obtainable or obtained) by means of a polar solvent or polar solvent mixture in water at a weight ratio, based on the total weight of dry green tea, water and polar solvent (mixture), of polar solvent (mixture) to water of from 5:95 to 90:10, preferably from 10:90 to 80:20, in particular from 30:70 to 70:30, preferably by extraction in the range up to the boiling temperature of the respective mixture, for example at 80 to 105° C., wherein the extract is used as a liquid or after drying in solid form, in this case in particular as granules or preferably as a powder.

In all embodiments of the invention, a polar solvent is preferred which is miscible with water and which consists of alcohol, in particular methanol, ethanol, propanol or isopropanol, a diol, in particular ethylene glycol, diethylene glycol or triethylene glycol, a ketone, in particular acetone or methyl ethyl ketone, a di-lower alkyl sulfoxide, in particular dimethyl sulfoxide or diethyl sulfoxide, a nitrile, such as acetonitrile, a water-soluble ether, such as dioxane or tetrahydrofuran, an amide, such as formamide, N-methylformamide, dimethylformamide or diethylformamide, and a heterocyclic solvent, such as piperidine or N-methyl-2-pyrrolidone, or a mixture of two or more thereof.

Insofar as a supercritical solvent is used, the invention relates in a further embodiment to such a solvent which is selected from nitrous oxide, sulfur dioxide, a fluorohydrocarbon or in particular carbon dioxide; a mixture of polar organic solvent and supercritical solvent is also possible.

In a particular embodiment, the invention relates to a use wherein the extract of green tea is one in which 100 to 300 parts of green tea have been used with 300 to 900 parts of water and 200 to 600 parts (in each case by weight) of the polar solvent, in particular ethanol, to prepare the extract.

Advantageously, when used in the extraction according to the invention, the ratio of the weights of green tea to water to polar solvent, in particular ethanol, is (10-30):(40-60):(25-40), preferably such that the sum of the ratios is one hundred.

A particular embodiment of the invention also relates to a tanning agent and/or substance for retanning, comprising a tanning agent-containing product which can be produced or is produced as defined in the above embodiments, in particular for tanning and/or retanning hides or skins or intermediate products thereof obtained during leather production. In a particular variant of this embodiment, the tanning agent and/or substance for retanning (i.e. the corresponding material) comprises an extract of green tea as defined in one of the above embodiments. Combinations with syntans and/or lignins are also conceivable embodiments of the invention.

A further embodiment of the invention relates to a method for vegetable tanning and/or retanning, characterized in that a tannin-containing product produced in accordance with one of the above embodiments, or a tanning agent and/or substance for retanning in accordance with the last paragraph, is added to a hide, a rawhide or, in the case of retanning, to a material already tanned from said materials, in aqueous solution or dispersion, with or without further additives, and the batch is incubated for a prolonged period of time, for example 0.1 to 5 days, for example 0.5 to 3 days, preferably with agitation in each case.

The invention also relates to the embodiments defined below and in the claims.

### DETAILED DESCRIPTION

The most important preferred embodiments for various methods and processes are described below.

The extraction with water and one or more polar (organic) solvents is preferably carried out by extracting a tannin-containing plant material, for example bark (e.g. oak, spruce, mimosa or willow bark), wood (e.g. oak, quebracho or chestnut wood), roots (e.g. badan, canaigre), stems, leaves or petals (e.g. sumac or gambir or in particular green tea from Camellia sinensis or furthermore assamica), fruits (e.g. valonea, trillo, myobalans or tara) or outgrowths (e.g. galls or knoppers) or seeds, which are extracted in unaltered or dried, in each case non-comminuted or comminuted (e.g. chopped or ground) form.

The extraction is preferably carried out by heating with the extraction agent (mixture of water and one or more polar solvents), for example to temperatures between 50° C. and the boiling point of the respective preparation (=extraction agent plus plant material to be extracted), for a sufficient time, for example over a period of 0.5 to 10 hours, such as in particular from 2 to 5 hours, for example (based on the mass or, under normal conditions of gravity, the weight of the plant material to be extracted) in a ratio of mass of plant material:mass of extraction agent of 10:1 to 1:100, preferably of 5:1 to 1:25, in particular of 3:1 to 1:10.

The extracts obtainable or obtained in this way can be obtained, optionally after filtering off solid constituents, after further dilution or as such or in liquid form concentrated by partial removal of the extraction agent (for example by distillation or evaporation, in each case with or without negative pressure), or after complete drying (e.g. by evaporation of the extracting agent, spray drying, fluidized bed process, freeze drying or the like) in dried form, for example as solid masses, granules or (in particular after grinding) or as a powder, and stored (e.g. under refrigeration) and later added to the respective liquor during tanning or retanning.

The residues after extraction with water or with a supercritical solvent as extraction agent are obtained in the same way, in that the soluble components of the tannin-containing plant material are transferred into solution with the extraction agent and discarded, and the remaining residue is then used as the basis for a tanning agent.

The tanning with an extract (or a residue) to be used according to the invention is carried out according to conventional processes, for example in a process for tanning and/or retanning hides and/or skins, in particular rawhides, or in the case of retanning pre-tanned hides and/or skins, in a liquor, comprising the steps of:
providing a skin and/or a hide or a rawhide or, in the case of retanning, a pre-tanned skin or a pre-tanned hide in a liquor,
adding the extract (or residue) to the hide, skin, rawhide or pre-tanned hide or leather or two or more of the above materials in the liquor,
acting of the extract added to the liquor on the materials mentioned in a penetration step, with or without coloration,
   wherein advantageously a refatting step (fatliquoring) is then carried out with a refatting agent (fatliquor) and, if necessary, the pH is adjusted with an organic acid, in particular formic acid, to a value between 2.5 and 5, in particular between 3 and 4, and a resulting vegetable-tanned or vegetable-retanned skin and/or fur product is obtained after washing with water.

The usual post-treatment steps can follow, such as turning to loosen, jacking up, aligning, drying (e.g. in a vacuum), studding or fulling.

The examples contain embodiments of methods, measurement methods for parameters and other steps.

The following examples serve to illustrate the invention without limiting its scope.

Definition of branded products mentioned:
BORRON® SAF—Anionic stabilizer for fatliquors with softening effect
CORIPOL® SLG—Anionic fatliquor for all soft and hard-scarred leather articles, based on a combination of natural and synthetic fats
CORIPOL® BZE—N-Anionic fatliquor for shoe uppers based on a combination of sulfated natural fats
TANIGAN BN pwd.—Anionic exchange tanning agent for the tanning and retanning of soft and full leathers, based on methylene condensation products of arylsulfonic acid and hydroxyarylic acid
SELLATAN MBS gran.—Tanning agent with good light fastness, based on anionic condensation products of phenolic sulfonic acid
SELLASOL® CV Conditioning agent
MAGNOPAL® Pure A organic filler
SELLAR FAST Brown HF-R metal complex dye
SELLAR FIX E Formaldehyde-free fixing agent for anionic dyes

These are always trademarks of TFL Ledertechnik GmbH, Rheinfelden, Germany.

### Example 1: Green Tea Extract Extraction with Water or Water/Ethanol Mixtures

a) Extract with Water:

In a 3-liter reactor with a three-blade stirrer (2 stages), 400 g of green tea and 2000 g of demineralized water were added, the stirrer switched on and heated to boiling point (temperature set to 99° C.). After 3 hours and thirty minutes, the mixture was cooled while stirring (temperature set to 20° C.). After a further 2 hours and thirty minutes, the reactor was placed in a water bath at 47° C., stirring was stopped, the reactor was emptied and the mixture was filtered through a sock filter. After drying at 105° C., the filtrate had a dry content of 6.75% by weight, based on the original filtrate.

b) Extract with Water and Ethanol:

In a 3-liter reactor with a three-blade stirrer (2 stages), 400 g of green tea, 1200 g of demineralized water (50%, based on both solvents 60%) and 800 g ethanol (33.33%, based on both solvents 40%)), the stirrer was set at 150 rpm and heated for 20 min in a water bath set at 50° C., then 25 min in a water bath set at 60° C., then 15 min in a water bath set at 70° C., then 15 min in a water bath set at 80° C., then 15 min in a water bath set at 90° C. until the water/ethanol mixture boiled after a further 15 min. The mixture was allowed to boil for three hours and thirty minutes with stirring. It was then cooled with stirring (temperature adjusted to 20° C.). After a further 2 hours, the mixture was transferred to a water bath at 53.6° C., stirring was stopped, the reactor was emptied and the mixture was filtered through a sock filter. After drying at 105° C., the filtrate had a dry content of 6.5% by weight, based on the original filtrate.

Both extracts were stored as a liquid in a refrigerator at 10° C. until use.

### Example 2: Importance of Ethanol in the Extraction of Green Tea for its Effectiveness as a Tanning Agent Using the Example of a Liquid Extract of Green Tea

| | |
|---|---|
| Article | Shoe leather |
| MATERIAL | Rawhide, pieces |
| | Depickled rawhides |
| COLOR | Natural |

| Process | % | Product | Time | | Comments |
|---|---|---|---|---|---|
| Tanning | | | | | |
| 1- 440 g | 170 | Green tea water extract | 120 min. + | | pH: 4.5: Cut sample after |
| | | Shake well | 240 min. | | 3.5 h |
| | | | | | TS after 48 h |
| 2- 440 g | 170 | Green tea water extract + | 120 min. + | | pH 4.9: Cut sample after |
| | | ethanol added to the water | 240 min. | | 3.5 h |
| | | extract - shake well | | | TS after 48 h |
| 3 - 440 g | 170 | Liquid green tea extract - water + | 120 min + | | pH 5.4: Cut sample after |
| | | ethanol for extraction - shake well | 240 min | | 3.5 h |
| | | | | | TS after 48 h |
| Everything | | Incubate in the tanning barrel for | 120 | min. | TS 2 |
| | | one day | | | |
| Addition | 6 | Mimosa 2 days | | | |
| FATLIQUOR | 50 | Water, 45 °C | | | |
| | 16 | Mixture of commercially | | | |
| | | available fatliqors | | | |
| | | Overnight, without heating | 120 | min. | |
| | 50 | Water, 45 °C | 20 | min. | |
| | 4 × 1 | Formic acid, 75% | 3 × 30 min. + | | pH: 3.5-3.6 |
| | | | 60 min. | | |
| WASH | 300 | Water, 40 °C | 10 | min. | |
| WASH | 300 | Water, 30 °C | 15 | min. | |

Jack up overnight, dry on the slope, cleating
TS = shrinkage temperature (measure of the strength of the cross-linking compounds in the fine structure of the skin), is determined as described in the general part of the description.

### Evaluation of the Resulting Dried Leather:

| | | | 3 Extract to be |
|---|---|---|---|
| | | 2 | used according |
| | | Green tea water | to the invention |
| | | extract with the | obtained by |
| | 1 | addition of | extraction with |
| | Green tea water | ethanol to the | water + ethanol |
| TA220170 | extract | water | (example 1) |
| Color | Greenish/ beige/ | Dark brown | Medium |
| | yellowish | | yellowish brown |
| Equality | 0 | 0 | +1 Recognizably |
| | | | higher equality |
| Penetration in | 80% | 70-80% | 80% |
| the finished | | | More uniform cut |
| leather | | | |
| Classification | 3 | 2 | 1 |
| (1 = best) | | | |
| TS °C after 3.5 h | 58 °C | 56 °C | 52 °C |
| only with the | | | |
| respective tea | | | |
| extract | | | |
| TS °C before | 57 °C | 56 °C | 62 °C |
| Mimosa, only | | | |
| with the | | | |
| respective tea | | | |
| extract | | | |
| TS °C after | 62 °C | 62 °C | 71 °C |
| Mimosa, at the | | | |
| end | | | |

Note on the use of the table: +3/−3 extreme manifestation, +2/−2 significant manifestation, −1/+1 manifestation, −0.5/+0.5 slight manifestation, 0 reference value.

The extract produced with ethanol/water according to the invention showed surprisingly clear advantages in the tanning effect (high dry matter content) and high evenness. Extraction with ethanol/water improved the tanning performance. The addition of ethanol to aqueous green tea extract did not show any improvements; consequently, the higher tanning effect depends on the extraction with ethanolic water and not solely on the ethanol content in the liquor.

### Example 3: Tanning in Comparison with Mimosa Extract as Powder

| | |
|---|---|
| ARTICLE | Upper shoe |
| MATERIAL | Pickled skin, pieces + 20% to the pickled weight |
| COLOR | Natural |

| Process | % | Product | Time | | Comments |
|---|---|---|---|---|---|
| DEPICKLING/ | | Water, 20 °C | | | |
| TANNING | 50 | Water, Pickling liquor | | | pH 3.0 |
| | | | | | Beaumé°: 6.5 |
| | 4 | Sodium formate | | | |
| | 1 | BORRON ® SAF | | | |
| | 2 | CORIPOL ® SLG | | | |
| | 2.3 | Sodium bicarbonate | 120 | min. | pH: 7.1 Cut |
| | | | | | Indicator |
| | | | | | Bromocresol |
| | | | | | green (BCG): |
| | | | | | Cut blue |
| | | Overnight, slowly | | | |
| | 8 | SELLASOL CV | 90 | min | pH 7.6 |
| | | (conditioning agent) | | | |
| | 100 | Water, 20 °C | 20 | min | |
| | | Separate pieces | | | |
| | 100 | Dye liquor | | | |
| 1 | 40 | Mimosa | 120 | min. | |
| 2 | 20 | Green tea extract | 120 | min. | |
| | | Overnight | | | |
| | | slow, 2 days | | | |
| FATLIQUOR | 100 | Water, 45 °C | | | |
| | 1 | BORRON ® SAF | | | |
| | 8 | CORIPOL ® BZE-N | | | |
| | 10 | CORIPOL ® SLG | 120 | min. | |
| | 6 | Formic acid, 75% | 3 × 20 | min. | pH: 3.4 |
| WASH | 300 | Water, 40 °C | 10 | min. | |
| WASH | 300 | Water, 30 °C | 15 | min. | |

Note on table usage: +3/−3 extreme manifestation, +2/−2 significant manifestation, −1/+1 manifestation, −0.5/+0.5 slight manifestation, 0 reference value

### Results of the Evaluation:

| | | 2 Green tea |
|---|---|---|
| | 1 | extract |
| | Mimosa 40% | 20% (powder) |
| Color | 0 | −0.5 |
| | brown | brighter |
| | | yellowish |
| Equality | 0 | +0.5 |
| Softness | 0 | −0.5 |
| | Very soft | solid compact |
| | Spongy | |
| Fullness | 0 | −0.5/−1 |
| | Full | |
| Touch | Silky and waxy | Silky dry |
| Grain break | 0 | +1/+1.5 |
| Incisional hernia | Stretched, | Flat scars |
| | pulled scar | |
| | Drawn scars | |
| Notes | Complete | Complete |
| | penetration | penetration |
| TS °C | 77 °C | 67 °C |

The special and really extraordinary thing about the experiment described above is that the amount of 40% powdered mimosa extract could be more or less replaced with 20% green tea extract. This enables a significant saving in tannin.

### Example 4: Retanning of Leather Tanned with Glutardialdehyde Using Green Tea Extract Powder (Extracted with Ethanol/Water)

| | |
|---|---|
| ARTICLE | Shoe |
| MATERIAL | Glutardialdehyde tanned leather, 1.1 mm |
| Color | Beige |

| Process | % | Product | Time | | Comments |
|---|---|---|---|---|---|
| WASH | 300 | Water, 30 °C | | | |
| | 0.3 | BORRON ® SAF | | | |
| | 0.5 | Formic acid 85% (1:5) | 20 | min. | pH 3.7 |
| NEUTRALIZATION | 150 | Water, 30 °C | | | |
| | 8 | SELLASOL ® CV | 40 | min. | pH 4.8-5.2 |
| | | (conditioning agent) | | | |
| A | 20 | Tara | 60 | min. | |
| B | 10 | Green tea extract 50% | 60 | min. | |
| | | polyphenol | | | |
| | 4 | COMMERCIALLY | | | |
| | | AVAILABLE | | | |
| | | FATLIQUORING AGENT | | | |
| | 6 | MAGNOPAL ® Pure A | 120 | min. | |
| | | organic filler | | | |
| | | Move slowly overnight | | | |
| | 50 | Water, 45 °C | | | |
| | 2 | Formic acid, 85% | 2 × 30 | min. | pH: 3.7-4.0 |
| WASH | 300 | Water, 45 °C | 10 | min | |
| FATLIQUORING | 150 | Water, 45 °C | | | |
| | 14 | Mixture of commercially | | | |
| | | available fatliquors | | | |
| | | | 90 | min. | |
| | 50 | Water, 45 °C | | | |
| | 2 | Formic acid, 85% | 2 × 20 | min | pH 3.7 |
| WASH | 300 | Water, 45 °C | 10 | min | |
| WASH | 300 | Water, 20 °C | 10 | min. | |

Jack up overnight, align, vacuum dry, 45 °C/3 min, cleating, fulling.

### Results of the Evaluation:

| | | B 10% green |
|---|---|---|
| TA 220005 | A 20% Tara | tea extract |
| Color | 0 | +1 |
| Uniformity of coloration | 0 | 0/−0.5 |
| Softness | 0 | +1 |
| Fullness | 0 | −0.5 |
| Tautness | 0 | 0/+0.5 |

Note on table usage: +3/−3 extreme manifestation, +2/−2 significant manifestation, −1/+1 manifestation, −0.5/+0.5 slight manifestation, 0 reference value

It is surprising to note that only half the amount of powder is needed for a similar tanning effect with the green tea extract as for the tara known as a vegetable tanning agent. Nevertheless, the leather properties are comparable.

### Example 5: Retanning Chrome-Tanned Leather (Better Result with the Same Amount Used)

| MATERIAL | US Wet Blue | | | | |
|---|---|---|---|---|---|
| | 1.1 mm 1 skin in 4 pieces | | | | |
| | % based on shaved weight | | Color: | brown | |
| Process | % | | Time | Comments | |
| WASH | 300 | Water, 30 °C | | | |
| | 0.3 | Formic acid, 85% | 10 min | | pH 3.4 |
| NEUTRALIZATION | 150 | Water, 30 °C | | | |
| | 2 | Sodium formate | 20 min. | | |
| | 1.5 | Sodium bicarbonate | 90 min. | | pH 5.9 |
| WASH | 300 | Water, 30 °C | 10 min. | | |
| Coloring | 150 | Water, 30 °C | | | |
| 1 | 10 | TANIGAN BN powder. | 120 min. | | pH 5.0 |
| 2 | 10 | SELLATAN MBS gran. | 120 min. | | pH 5.1 |
| 3 | 10 | Tara | 120 min. | | pH 4.6 |
| 4 | 10 | Green tea extract | 120 min. | | pH 5.0 |
| | | (powder) | | | |
| | 100 | Water 50 °C | | | |
| | 1.0 | Formic acid, 85% | 30 min. | | |
| | 1.0 | Formic acid, 85% | 30 min. | | pH 3.8 |
| WASH | 300 | Water, 50 °C | 10 min. | | |
| WASH | 300 | Water, 50 °C | | | |
| | 0.5 | Sodium bicarbonate | 10 min | | pH 5.4 |
| | 3 | SELLA FAST Brown HF-R | 30 min. | | |
| | 14 | CORIPOL ® MK | 60 min. | | |
| | 1.0 | Formic acid, 85% | 30 min. | | |
| | 1.5 | Formic acid, 85% | 30 min. | | pH 3.5 |
| WASH | 300 | Water, 50 °C | 10 min. | | |
| WASH | 300 | Water, 30 °C | | | |
| | 0.5 | SELLA ® FIX E | 30 min. | | |

Note on table usage: +3/−3 extreme manifestation, +2/−2 significant manifestation, −1/+1 manifestation, −0.5/+0.5 slight manifestation, 0 reference value

Surprisingly, comparable to better properties of the leather were found with the same amount of extract.

### Example 6: Tanning for the Production of Vegetable Leather

| | |
|---|---|
| ARTICLE | Shoe leather |
| MATERIAL | Rawhide |
| | Depickled rawhide |
| Color | Natural |

| Process | % | Product | Time | | Comments |
|---|---|---|---|---|---|
| | 100 | Water, 20 °C | 20 | min | |
| | | Separate parts | | | |
| 1 | 40 | Mimosa (REFERENCE) | 120 | min. | |
| 2 | 40 | Green tea extract 20% | 120 | min. | |
| | | polyphenol | | | |
| 3 | 40 | Tara | 120 | min. | |
| | | Tanned at slow speed (5-8 | | | After 24 h |
| | | rpm)- 48 hours in the barrel | | | Cutting out |
| | | | | | pieces |
| FATLIQUOR | 100 | Water, 45 °C | | | |
| | 19 | Mixture of common | | | |
| | | fatliquors | | | |
| | | | 120 | min. | |
| | 6 | Formic acid, 75% | 3 × 20 | min. | pH: 3.3 |
| WASH | 300 | Water, 40 °C | 10 | min. | |
| WASH | 300 | Water, 30 °C | 15 | min. | |

Tara is a plant tannin obtained from the small tara tree (Cesalpina spinosa).

### Leather Evaluation:

| | | 2 GREEN TEA | |
|---|---|---|---|
| | 1 | EXTRACT 20% | |
| | MIMOSA | POLYPHENOL | 3 TARA |
| TA 210417 | (powder) | (powder) | (powder) |
| Color | Reddish | Dark beige | Beige |
| | brown | | |
| Equality | 0 | +0.5 | +0.5 |
| Softness | 0 | +0.5 | −0.5 |
| Fullness | 0 | 0 | 0/−0.5 |
| TS °C | 75 °C | 73 °C | 65 °C |

1/+1 manifestation, −0.5/+0.5 slight manifestation, 0 reference value

It turns out that the green tea extract delivered about as good results as mimosa extract and better results than tara.

1. A method of tanning and/or retanning hides or skins or intermediate products thereof resulting from leather production, the method comprising:
preparing a tannin-containing product by extracting a vegetable tannin-containing material using a variant
(i) an aqueous solution or dispersion containing one or more polar organic solvents in the form of an extract, or
(ii) a supercritical solvent in the form of a residue of the extraction, or
(iii) pure water in the form of a residue of the extraction, or
(iv) a mixture of a supercritical and a polar solvent in the form of a residue of the extraction, and
adding the extracted vegetable tannin-containing material to a batch of the hides or the skins or the intermediate products resulting from leather production for tanning and/or retanning.

2. The method according to claim 1, wherein the extracted tannin-containing product is obtainable or obtained according to the variant (i) in liquid or dried form of the aqueous dispersion or solution containing the one or more polar organic solvents.

3. The method according to claim 1, wherein the tannin-containing product is a solid or dispersed residue, of an extraction with pure water or with a supercritical solvent, obtainable or obtained according to one of the variants (ii) or (iii).

4. The method according to claim 1, further comprising providing phenolic compounds as tanning agents in the respective product.

5. The method according to claim 1, wherein the tannin-containing product is an extract of green tea in liquid or dried form which contains or is the product of an extraction using an aqueous dispersion or solution containing one or more polar organic solvents.

6. The method according to claim 5, wherein the tannin-containing product made from the extract of green tea is used for retanning intermediate products obtained from hides or skins during leather production wherein the intermediate product or products is or are a material resulting after pickling, and this intermediate product is subjected to the tanning or the tanning with subsequent retanning, in each case using the extract of green tea.

7. The method according to claim 6, wherein the intermediate product or products is or are a material obtainable after a first tanning step, and the method further includes carrying out the retanning process with said material in each case using the extract of green tea.

8. The method according to claim 5, further comprising adding the extract of green tea of a respective liquor in solid, e.g. granular or powdery form, to a liquor for tanning or retanning.

9. The method according to claim 5, further comprising adding the extract of green tea to a respective liquor in liquid form.

10. The method according to claim 5, wherein the extract of green tea is obtained by a polar solvent or polar solvent mixture in water at a weight ratio, based on a total weight of dry green tea, water and polar solvent (mixture), of polar solvent (mixture) to water from 5:95 to 90:10, by extraction in a range up to a boiling temperature of the respective mixture, wherein the extract is used as a liquid or after drying in solid form.

11. The method according to claim 1, wherein the polar solvent is a solvent which is miscible with water and which consists of alcohol, a diol, a ketone, a di-lower alkyl sulfoxide, a nitrile, a water-soluble ether, an amide, and a heterocyclic solvent, or a mixture of two or more thereof.

12. The method according to claim 1, wherein the supercritical solvent is selected from nitrous oxide, sulfur dioxide, a fluorohydrocarbon or carbon dioxide.

13. The method according to claim 5, wherein the extract of green tea is one in which 100 to 300 parts of green tea have been used with 300 to 900 parts of water and 200 to 600 parts (in each case by weight) of the polar solvent, to prepare the extract.

14. The method according to claim 5, wherein in the extraction a ratio of weights of green tea to water to polar solvent, is (10-30):(40-60):(25-40).

15. A tanning agent and/or substance for retanning, comprising as tanning component, a tanning agent-containing product including a vegetable tannin-containing material that is extracted using a variant
(i) an aqueous solution or dispersion containing one or more polar organic solvents in the form of an extract, or
(ii) a supercritical solvent in the form of a residue of the extraction, or
(iii) pure water in the form of a residue of the extraction, or
(iv) a mixture of a supercritical and a polar solvent in the form of a residue of the extraction.

16. The tanning agent and/or retanning agent according to claim 15, wherein the vegetable tannin-containing material is an extract of green tea.

17. The method comprising incubating the batch for a prolonged period of time, for example 0.1 to 5 days, preferably with agitation.

18. The method of claim 5, wherein the method is for retanning a semi-finished leather product, and the method further comprising treating the semi-finished leather product with the extract of green tea as the tanning agent in an aqueous solution.

19. The method according to claim 12, wherein supercritical solvent is mixed with a polar organic solvent.
